(19) United States
(12) Patent Application Publication
(10) Pub. No.: US 2015/0039864 A1
(43) Pub. Date: Feb. 5, 2015

(54) SYSTEMS AND METHODS FOR DEFEATING MALWARE WITH RANDOMIZED OPCODE VALUES

(71) Applicant: John Patrick Edgar Tobin, San Jose, CA (US)

(72) Inventor: John Patrick Edgar Tobin, San Jose, CA (US)

(73) Assignee: EBAY INC., SAN JOSE, CA (US)

(21) Appl. No.: 14/105,788

(22) Filed: Dec. 13, 2013

Related U.S. Application Data
(63) Continuation-in-part of application No. 13/956,191, filed on Jul. 31, 2013.

(51) Int. Cl. G06F 9/30; G06F 21/64

(52) U.S. Cl. CPC G06F 9/3017; G06F 21/64
USPC 712/220

(57) ABSTRACT

A computer processor includes a first instruction set and a second instruction set. The computer processor further includes a translator. The translator translates the first instruction set into the second instruction set. The computer processor is configured to execute operations using only the second complete instruction set.

### RELATED APPLICATION

This application claims priority to U.S. application Ser. No. 13/956,191, filed on Jul. 31, 2013 and entitled System and Methods for Defeating Malware with Polymorphic Software, which is hereby incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

This disclosure relates to the technical field of software development and hardware implementation, and more particularly, to systems and methods for defeating malware with randomized opcode values (or alternate instruction set values).

### BACKGROUND

The ubiquitous deployment of computer software has resulted in immeasurable benefits to those who use computers. Notwithstanding this incontrovertible gain, the quiet enjoyment of those users is continually threatened by the pestilence of malware.

### BRIEF DESCRIPTION OF THE DRAWINGS

Embodiments illustrated, by way of example and not limitation, in the figures of the accompanying drawings, in which:

FIG. 1 illustrates a computer infected with malware, according to an embodiment;

FIG. 2A is a block diagram of a system, according to an embodiment, for use in connection with defeating malware;

FIG. 2B is a block diagram illustrating function information, according to an embodiment;

FIG. 3A is a block diagram illustrating instruction information, according to an embodiment, that utilizes absolute address information and a base offset;

FIG. 3B is a block diagram illustrating instruction information, according to an embodiment, that utilizes relative address information and an instruction offset;

FIG. 4A illustrates an example of a translated instruction set;

FIG. 4B illustrates another example of a translated instruction set;

FIG. 4C illustrates a program function coded in a native instruction set and the program function translated into a translated instruction set;

FIG. 5 is a block diagram illustrating a software development process, according to an embodiment;

FIG. 6 is a block diagram illustrating a software development process, according to an embodiment;

FIG. 7 is a block diagram illustrating a method, according to an embodiment, to defeat malware;

FIG. 8 is a block diagram illustrating a method, according to an embodiment, to generate randomized image information, generate map information, and update instruction information; and

FIG. 9 shows a diagrammatic representation of a machine in the example form of a computer system, according to an example embodiment.

### DETAILED DESCRIPTION

Examples of systems and methods are directed to defeating malware using randomized opcode values (or instruction set values). In the following description, for purposes of explanation, numerous specific details are set forth in order to provide a thorough understanding of some example embodiments. It will be evident, however, to one of ordinary skill in the art that embodiments of the present disclosure may be practiced without these specific details. Further, it will be evident to one skilled in the art that well-known instruction instances, protocols, structures, and techniques have not been shown in detail.

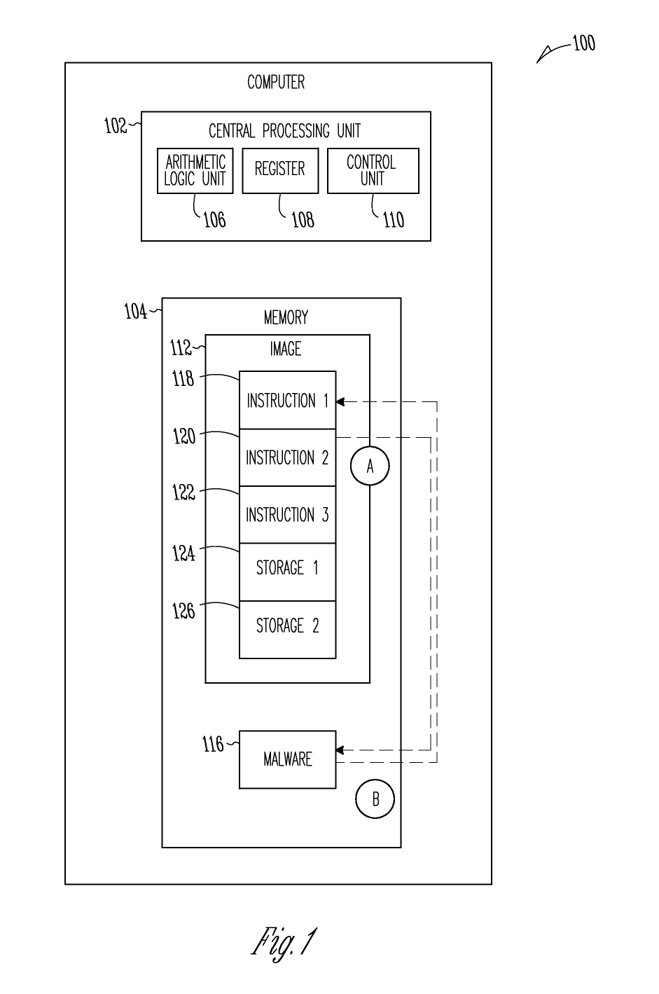

FIG. 1 illustrates a computer 100 infected with malware, according to an embodiment. The computer 100 includes a central processing unit 102 (CPU) and memory 104. The central processing unit 102 may include an arithmetic logic unit 106 (ALU) for executing instructions, one or more registers 108 for temporary storage, and a control unit 110 (CU). The memory 104 may include an image 112 and malware 116. The image 112 may include multiple instructions 118, 120, 122 (e.g., respectively numbered “1,” “2,” and “3”) and multiple blocs of storage 124, 126 for storing data (e.g., respectively numbered “1,” and “2”). Broadly, the CPU 102 may utilize the CU 110 to fetch instructions 118, 120, and 122 into the ALU 106 where they are executed. Execution is typically sequential (e.g., one instruction after the next) unless a jump instruction, a branch instruction, an interrupt, a process time slice, or a code induced exception is executed, thereby causing the execution of an instruction other than the one next stored in the memory 104. A handful of companies manufacture the vast majority of CPUs that are available on the market, and the instructions 118, 120, and 122 are specific to a particular manufacturer's CPU or line of CPUs.

At operation “A,” the malware 116 is illustrated as wrestling control from the instruction 120 (i. e, instruction 2) by means of an exploit, vulnerability, or some other trickery. At operation “B,” the malware 116 may invoke the instruction 118 (e.g., instruction 1) to perform a standard task. Instruction 118 is not malware 116. Rather, instruction 118 is part of the image 112 and may be utilized to provide a standard service such as printing or displaying. It is important to recognize the location of the instruction 118 in the image 112 as being fixed relative to the other instructions 120 and 122. The malware 116 may branch or jump to the instruction 118 because the location of the instruction 118 in the image 112 relative to the other instructions is known and does not change. Additionally, the malware 116 uses its knowledge of the instruction set of the CPU 102, and in particular the operation codes and their values, to execute its pernicious instructions on the CPU 102.

To prevent malware 116 from using the instruction set of a CPU 102 to inflict harm onto the system run by the CPU 102, an embodiment randomly translates the native instruction set and its values into a second instruction set and corresponding new values. The second instruction set, being created by an individual or entity, and random in nature, is not known to those outside of the creators of the random instruction set, including the perpetrators of malware 116.

This translation system and method can be illustrated using the Intel instruction set as a guide. However, the system, method, and concept can be applied to any CPU and its instruction set. As a primary matter, the term instruction set refers to the underlying byte codes that represent the instructions read by the CPU from memory to create a program. Current CPUs have a fixed instruction set that persists across threads, processes, operating system instances, and other machines. For example, the instruction set that is running on a windows PC is identical or substantially similar to a co-worker's, colleague's, or friend's PC.

It is noted at this point that translating pure binary files (as in programs that contain x86 code for example) may pose a problem in the translation phase. Specifically, bytes in the binary file may not be actual code bytes but could be hard coded constants, pointers, etc. To overcome this potential problem, it can be helpful to add information to a file that identifies and distinguishes areas of code, areas of data, and other areas. For some technologies, such as Java and .Net applications (or similar applications), there is a very well-defined concept of what is data, what is code, and what is other information. Such files would therefore be easier to translate.

As noted above, for malware to infect a computer, the malware requires knowledge of the instruction set running on the computer. In most cases, this instruction set is well known. In an embodiment however, the instruction set that is understood and therefore executable by the CPU is created at the time that the operating system, process, or thread is instanced. Consequently, the instanced instruction set is currently and completely unknown to an outside would be infiltrator. For each type of instance that generates the randomized instruction set, it is required that this information of the currently instanced instruction set is associated to that instance, similar to a context information associated to a process, which allows for context switching. This is accomplished for example by the CPU being able to map the randomized instructions to the native instructions of the CPU 102, or using a seed value to translate the randomized instructions to the native instructions of the CPU 102.

The following is a simple example of a randomized instruction code using the Intel instruction set. In Intel assembly language, the following bytes translate as follows:

B8 11 22 33 44: MOV eax., 0x44332211
25 FF 45 67 89: AND eax, 0x896745FF
That is, these are two completely different byte codes representing two completely different operations (B8 vs. 25). In a randomized CPU instruction set, the following may now occur:
3D 11 22 33 44: MOV eax, 0x44332211 (which in normal Intel opcodes would be CMP EAX, 0x44332211). Additionally, as a result of the translation, B8 could now be NOT EAX (for example). As one can see, randomly unique byte values have been chosen to represent instructions. As noted above, these random unique byte codes are completely unknown to the outside world, which makes it more difficult for malware to infiltrate an operating system or process. After the generation of the unique byte code set, a translator converts programs written for standard original opcodes (such as the Intel instruction set) to the randomly chosen opcodes. This translation could be done by the operating system or with assistance from the CPU at the time a program is to be loaded for execution. This randomization of instruction set values may be utilized to defeat malware because malware may no longer be programmed based on knowledge of the CPU's instruction set.

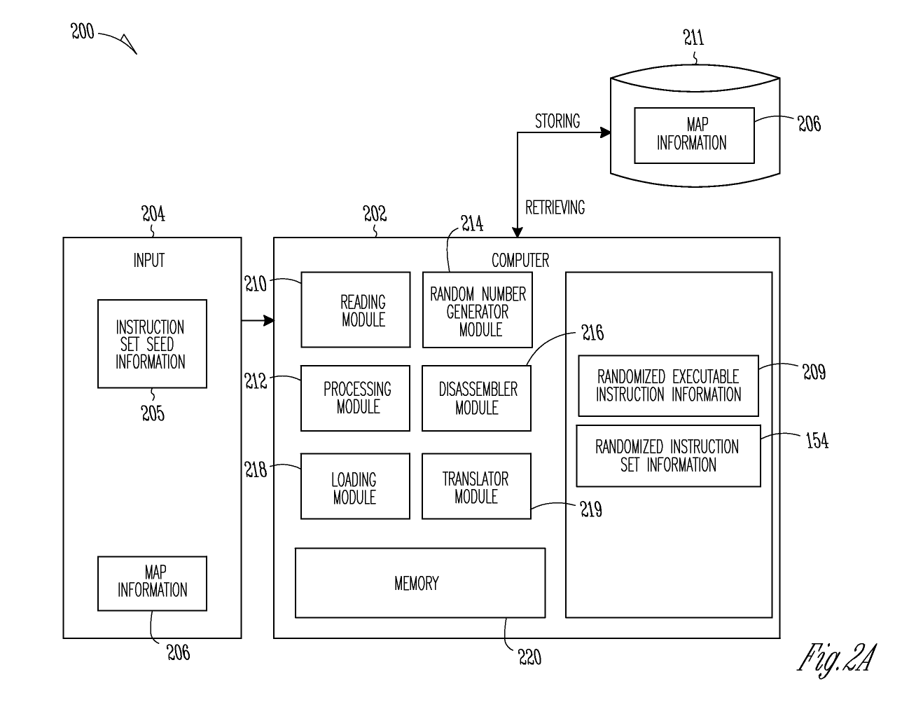

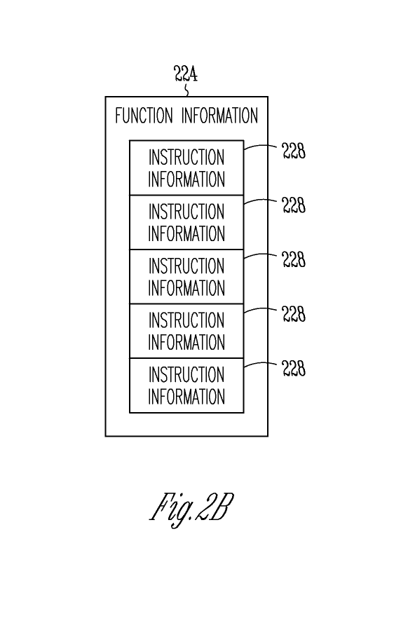

FIG. 2A is a block diagram of a system 200, according to an embodiment, to defeat malware using randomized instruction set values. The system 200 may include a computer 202 that receives input 204. The input 204 may include map information 206 and/or an instruction set seed 205. The computer 202 may generate map information 206 and randomized instruction set information 154 based on the input 204. In another embodiment, the map information 206 may be retrieved from persistent storage 211. In another embodiment, the map information 206 may be generated by the computer 202. In another embodiment, the input 204 may be received over a network. In another embodiment, the instruction set seed 205 may be retrieved from the memory 220 or persistent storage 211.

The computer 202 may include a reading module 210 to read the input 204 into the computer 202, a processing module 212 and translation module 219 to randomize the CPU's instruction set to generate the randomized instruction set 154, a random number generator module 214 to generate a random number that may be used as a seed to randomize the values of the CPU's native instruction set, a disassembler module 216 that may optionally be used to disassemble the randomized instruction set values 154, and a loading module 218 to link and load the randomized instruction set values into memory 220 at a specific base address for execution as randomized executable instruction information 209.

FIG. 2B is a block diagram illustrating function information 224, according to an embodiment. The function information 224 (e.g., a function) may include instruction information 228 (e.g., instructions). A function is a sequence of program instructions that may perform a specific task. The function information 224 may be referred to as a “procedure,” a “function,” a “routine,” a “method,” or a “subprogram.” The function may be invoked by other functions. The function information 224 may be started (called) several times and/or from several places during one execution of a program, including from other function information 224, and then branch back (return) to the next instruction after the call, once the functions is done. The function information allows a randomized instruction set to be implemented on a function basis, a process basis, a sub-process basis, a routine basis, a program basis, and/or a thread basis, just to list a few examples.

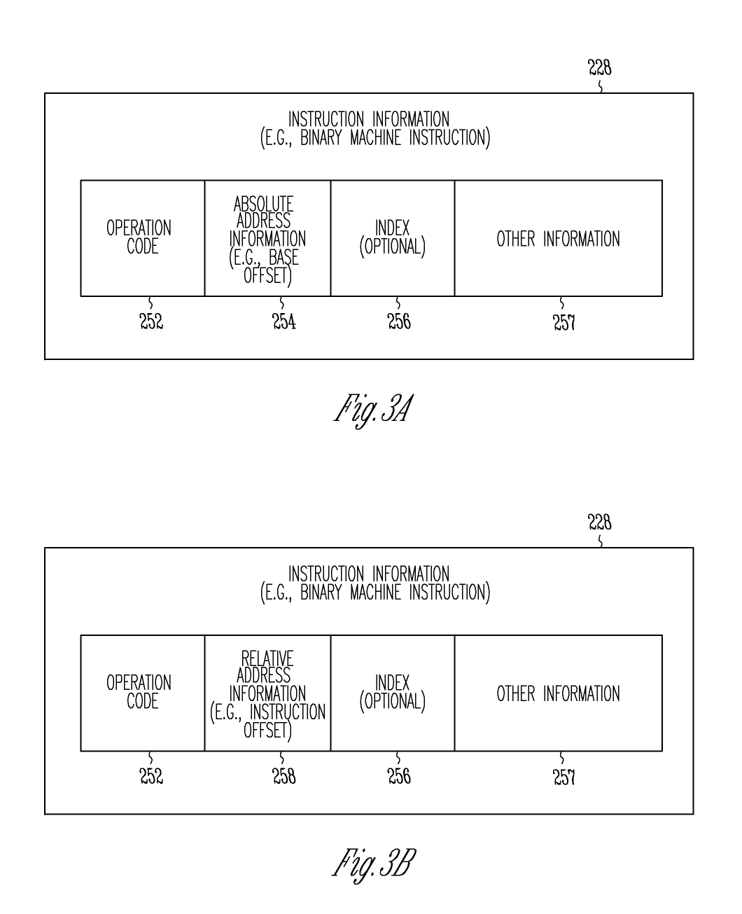

FIG. 3A is a block diagram illustrating instruction information 228 that utilizes absolute addressing, according to an embodiment. The instruction information 228 (e.g., instruction) may include an operation code 252 that determines the operation that is performed by the instruction (e.g., jump, load, store, etc.), absolute address information 254, an index 256 that may be utilized in the addressing, and other information 257.

The absolute address information 254 may include a base offset or an absolute address. The base offset may be a positive numeric value that identifies a location in a current executable image or zero which is a placeholder that signifies a location in another image to be resolved as export information at load time.

A positive numeric value may identify a location in a current image that includes instruction information 228. For example, a first function in an executable image may include instruction information 228 that includes absolute address information 254 that includes a base offset of “266.” Continuing with the example, the base offset of “266” may be added to a base address of “0” to identify instruction information 228 in a second function in the same image. Prior to immediately loading the executable image into the memory 220 and in preparation of execution: 1) an address (e.g., 600000) may be selected as the base address for the image; 2) the base address may be added to the base offset (e.g., 228) to generate an absolute address (e.g., 6000228); and 3) the absolute address may be written back into the absolute address information 254 of the instruction information 228.

FIG. 3B is a block diagram illustrating instruction information 228 that utilizes relative addressing, according to an embodiment. The instruction information 228 may include relative address information 258. The other fields are as previously described. The relative address information 258 may include an instruction offset that is relative to the location of the instruction information 228. The instruction offset may identify a location in the executable image. The relative address information 258 may be positive or negative and is limited in range by the size of the field that stores the instruction offset. The instruction offset may be added to the location of the instruction information 228 that includes the instruction offset to identify instruction information 228 in the same image or a storage location 230 in the same image. For example, a first function in the executable image may include instruction information 228 (e.g., Instruction 1) that includes relative address information 258 that includes an instruction offset that may be added to the location of the instruction information 228 (e.g., Instruction 1) to identify the location of instruction information 228 (e.g., Instruction 2) in a second function in the same executable image. In another embodiment, the instruction offset may be added to the location of the next instruction information 228 (e.g., Intel instruction formation) rather than the present instruction information 228.

The instruction information 228 that utilizes absolute addressing (as shown in FIG. 3A) and the instruction information 228 that utilizes relative addressing (as shown in FIG. 3B) may be included in a randomized instruction set. As noted, an instruction set is part of the architecture for a particular type of computer 202. The instruction set may be related to programming, including the native data types, instructions, registers, addressing modes, memory architecture, interrupt and exception handling, and external input/output. The instruction set may further define a set of operation codes 252 and the commands implemented by a particular processor (e.g., AMD's AMD64, Intel's Intel 64).

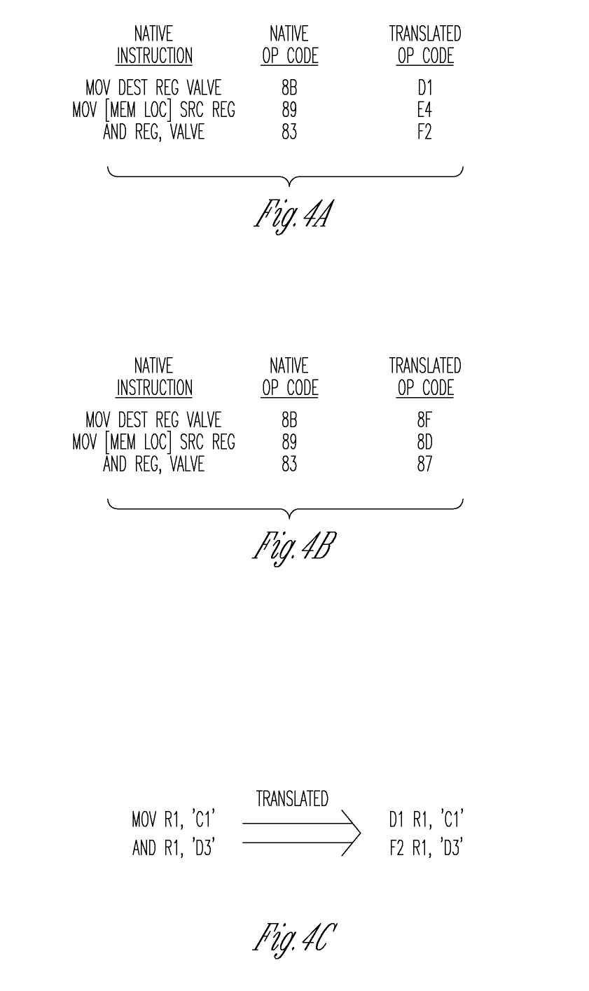

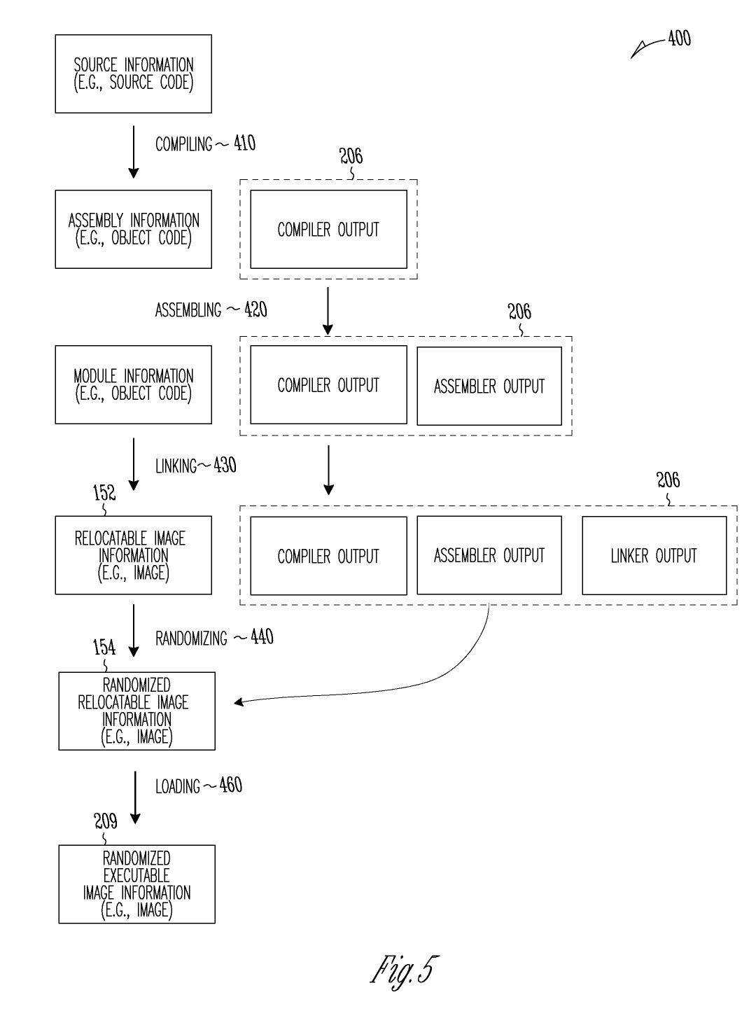

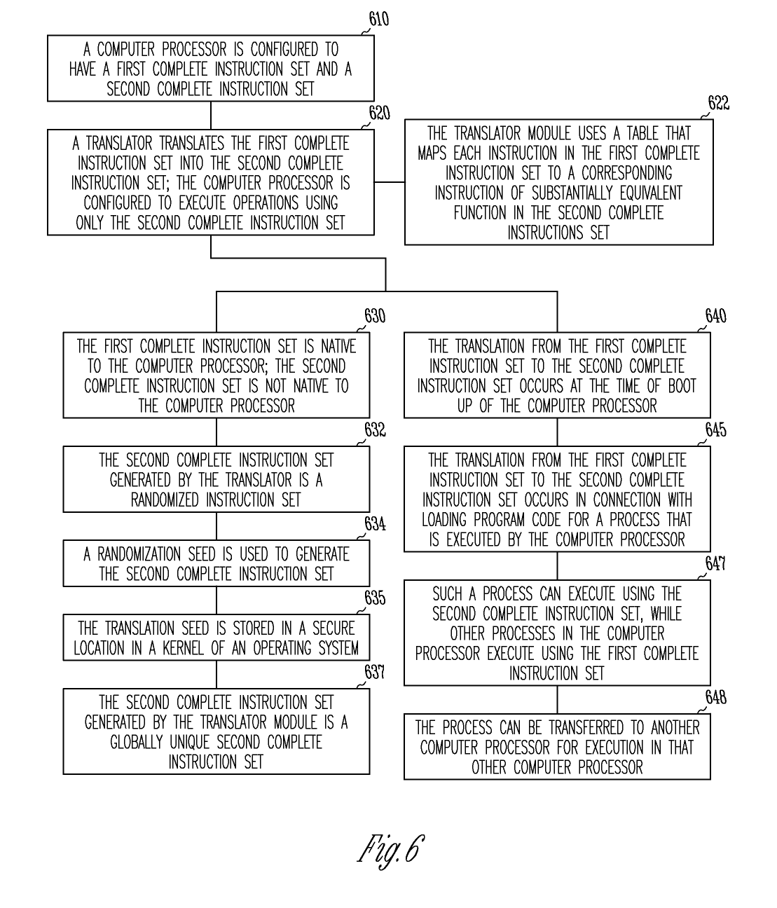

FIGS. 4A and 4B are diagrams illustrating a simplified example of translating a native instruction set for a CPU 102 into a translated instruction set for the CPU. FIG. 4A illustrates three instructions—Mov destReg, value; Mov [mem loc], srcReg; And reg, value. As can be seen from FIG. 4A, the native instruction codes (e.g., native op codes) for these commands are 8B, 89, and 83 respectively, the codes being represented in hexadecimal, a system of numerical notation that has 16 rather than 10 as its base. The translated values (e.g., translated op codes) for these instructions as illustrated in FIG. 4A are D1, E4, and F2. These native instruction values and the translated option values can be stored in the map information 206 (as shown in FIG. 2A). FIG. 4B illustrates a translation from the native instruction values to the translated instruction values using a seed value. The seed value can be stored in the instruction set seed information 205, and/or generated by the random number generator module 214 (as shown in FIG. 2A). In the simple example of FIG. 4B, a seed value of 4 is added to each native instruction code to obtain the translated instruction values. FIG. 4C is a diagram illustrating on the left of the arrow a simple program segment written in the native language of the CPU 102 as illustrated in FIG. 4A, and illustrating to the right of the arrow the same program segment translated into the randomized instruction set of FIG. 4A. Two instructions from FIG. 4A are being illustrated, namely the instruction “MOV DEST REG VALUE” and the instruction “AND REG, VALUE”. The first instruction moves the value of ‘C1’ into a register (e.g., R1), and the second instruction logically ‘ands’ the ‘C1’ value in that register (e.g., R1) with the value of ‘D3’. In an embodiment, the translation of opcode values is performed in a restricted, elevated, and secure environment. In another embodiment, the translation is executed in an environment that can validate the origin of binaries via cryptographic means. In an embodiment, the translated opcode can be a different length than the native opcode. A translated opcode of different length than the native opcode makes the position of opcodes jitter within the written binary file, thereby making assumptions by malware of opcode placement invalid.

Upon compilation or startup of an operating system or process, the process or program in native code is translated into the randomized instruction set. The CPU 102 is configured to execute the randomized instruction set via a knowledge of the mapping table 206 or the seed value used to generate the randomized instructions. Malware 116 will not be aware of the CPU 102's configuration to execute the randomized instruction set, nor the mapping table or seed value, and consequently, the CPU 102 will not understand the instructions of the malware 116. The CPU 102 may crash because of its inability to interpret the instructions of the malware 116, but the malware 116 will not be able to infiltrate the CPU and cause havoc in the CPU 102 or the associated computer system.

FIG. 5 is a block diagram illustrating a software development process 400, according to an embodiment. The software development process 400 may include a compiling process 410, an assembling process 420, a linking process 430, a randomizing process 440, and a loading process 460. The compiling process 410 may receive source information (e.g., source code) and compile the source code to generate assembly information (e.g., assembly code) and compiler output (e.g., map information 206). The assembling process 420 may receive the assembly information (e.g., assembly code) and the compiler output and assemble the assembly code to generate module information (e.g., object code) and assembler output (e.g., map information 206). The linking process 430 may receive one or more module information (e.g., object code) with associated compiler output and assembler output (e.g., map information 206) to generate image information 152 (e.g., object code) and linker output.

The randomizing process 440 may receive the image information 152 and the map information 206 and generate the randomized image information 154 (e. g., image with randomized instructions). The randomizing process 440 randomizes the instruction values as previously described, for example using mapping table 206 and/or seed information 205. The randomizing process 440 may receive the map information 206 that is generated from the compiling process 410, the assembling process 420, and the linking process 430. Other development processes may be associated with the above described steps and facilitate the generation of the map information 206. For example, the generation of the map information 206 may be facilitated by intermediate language. Further, the map information 206 may be embodied in many different forms that originate in many different types of development technology (e.g., Java.net, .NET, Java, etc.). In another embodiment, the map information 206 may be generated with the disassembler module 216. In another embodiment, the map information 206 may be retrieved from persistent storage 211.

The loading process 460 may receive the randomized image information 154 to generate and load the randomized executable image information 209 into the memory 220 of the computer 202. The randomized executable image information 209 may now be executed by the computer 202.

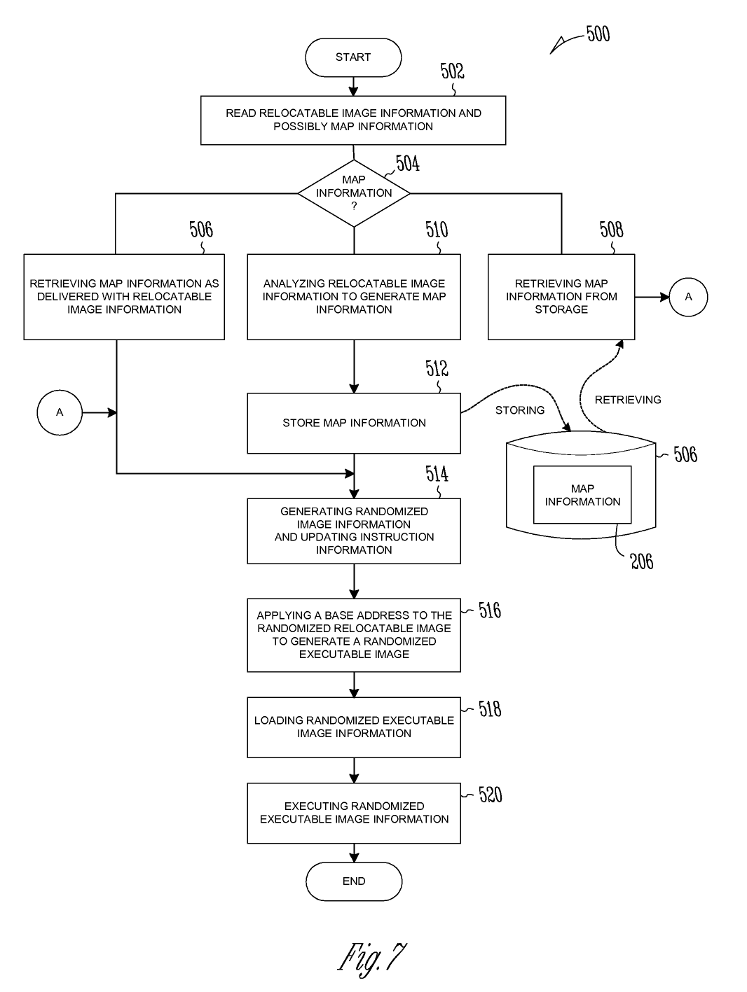

FIG. 6 is a block diagram illustrating another software development process 600, according to an embodiment. At 610, a computer processor is configured to have a first complete instruction set and a second complete instruction set. As indicated at 620, a translator module 219 translates the first complete instruction set into the second complete instruction set, and the computer processor is configured to execute operations using only the second complete instruction set. Block 622 illustrates that the translator module 219 can use a table that translates or maps each instruction in the first complete instruction set to a corresponding instruction of substantially equivalent function in the second complete instructions set. In such a translation or mapping, the byte code for each instruction in the first complete instruction set is different than the byte code for the corresponding instruction of substantially equivalent function in the second complete instruction set. As noted previously, instead of a translation table, a seed value can be used to generate the second complete instruction set.

Block 630 illustrates that the first complete instruction set is native to the computer processor, and the second complete instruction set is not native to the computer processor. As noted previously, the native instruction set of a processor is generally known to those of skill in the art who work with such processors. However, the second complete instructions set, which is a random creation, is unknown to those of skill in the art who work with such processors. As also noted previously, this configuration makes it more difficult for malware to infiltrate the processor. Block 632 illustrates that the second complete instruction set generated by the translator is a randomized instruction set. This randomization is the reason that the second instruction set is unknown to those of skill in the art. In an embodiment, as illustrated in FIGS. 4A and 4B, a one byte opcode may be translated into a different one byte opcode. In another embodiment, a one byte opcode may be translated into a two byte opcode. That is, the length of the opcode can be varied in the translated instruction set. A randomization seed can be used to generate the second complete instruction set, as noted above and as illustrated in block 634. The translation seed can be stored in a secure location in a kernel of an operating system (635). In another embodiment, as illustrated in block 637, the second complete instruction set generated by the translator module is a globally unique second complete instruction set. This global uniqueness applies to a particular computer processor, a particular instantiation of an operating system, a particular process executing in the computer processor, or a particular thread associated with the particular process. The global uniqueness may further involve the address of the code that is being executed and other variants.

In an embodiment, as illustrated at 640, the translation from the first complete instruction set to the second complete instruction set occurs at the time of boot up of the computer processor. In another embodiment, the translation from the first complete instruction set to the second complete instruction set occurs in connection with loading program code for a process that is executed by the computer processor (645). As illustrated in block 647, such a process can execute using the second complete instruction set, while other processes in the computer processor execute using the first complete instruction set. That is, the use of the second complete instruction set can occur on a process by process basis. Block 648 illustrates that the process can be transferred to another computer processor for execution in that other computer processor. In such a scenario, a translation table associated with the process or a translation seed associated with the process is also sent to the second computer processor so that the second computer processor can execute the process with the second, non-native, instruction set.

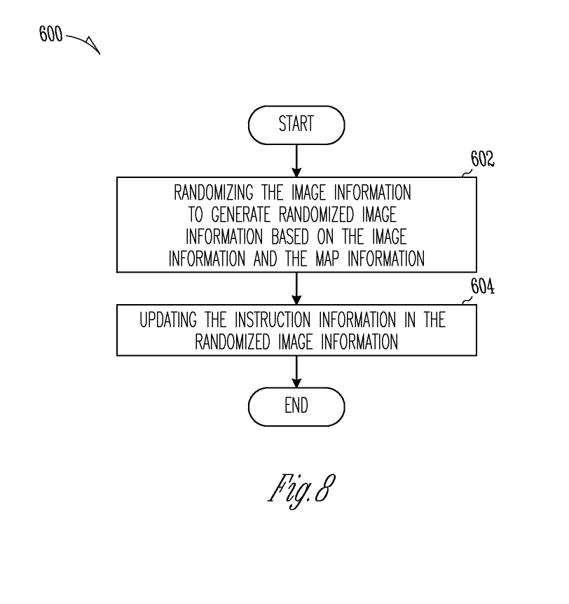

FIG. 7 is a block diagram illustrating a method 500, according to an embodiment, to defeat malware with a randomized instruction set. The method 500 may commence at operation 502, at the computer 202 (e.g., mobile phone, wearable device, personal computer (PC), set-top box, tablet, etc.), with the reading module 210 reading/receiving the image information 152. In one embodiment, the reading module 210 may further read/receive map information 206 that is associated with the image information 152. In one embodiment, the image information 152 and the map information 206 may be received over a network.

At decision operation 504, the processing module 212 may identify a source of map information 206 for generating the randomized image information 154. If the processing module 212 identifies the map information 206 as being received by the reading module 210, then processing continues at operation 506. Otherwise, the processing module 212 may identify whether map information 206 associated with the image information 152 is stored in persistent storage 211. For example, the processing module 212 may identify whether an image identifier that is included in the image information 152 matches an image identifier that is included in any of the map information 206 that is stored in persistent storage 211. If the processing module 212 identifies matching map information, then processing continues at operation 508. Otherwise the processing module 212 continues processing at operation 510. Other embodiments may apply the above described decisions in a different order.

At operation 506, the processing module 212 may retrieve the map information 206 that was received/retrieved with the image information 152. At operation 508, the processing module 212 may retrieve the map information 206 that matches the image information 152 from persistent storage 211 and processing continues at operation 514, as illustrated by the connector “A.” At operation 510, the processing module 212 may invoke the disassembler module 216 to analyze the image information 152 to generate the map information 206. For example, the disassembler module 216 may be embodied as a modified form of the Interactive Disassembler (IDA), a shareware application created by Ilfak Guilfanov that was later sold as a commercial product by DataRescue, a company located in Liege, Belgium. Other embodiments may use other disassembler modules 216 that disassemble the image information 152.

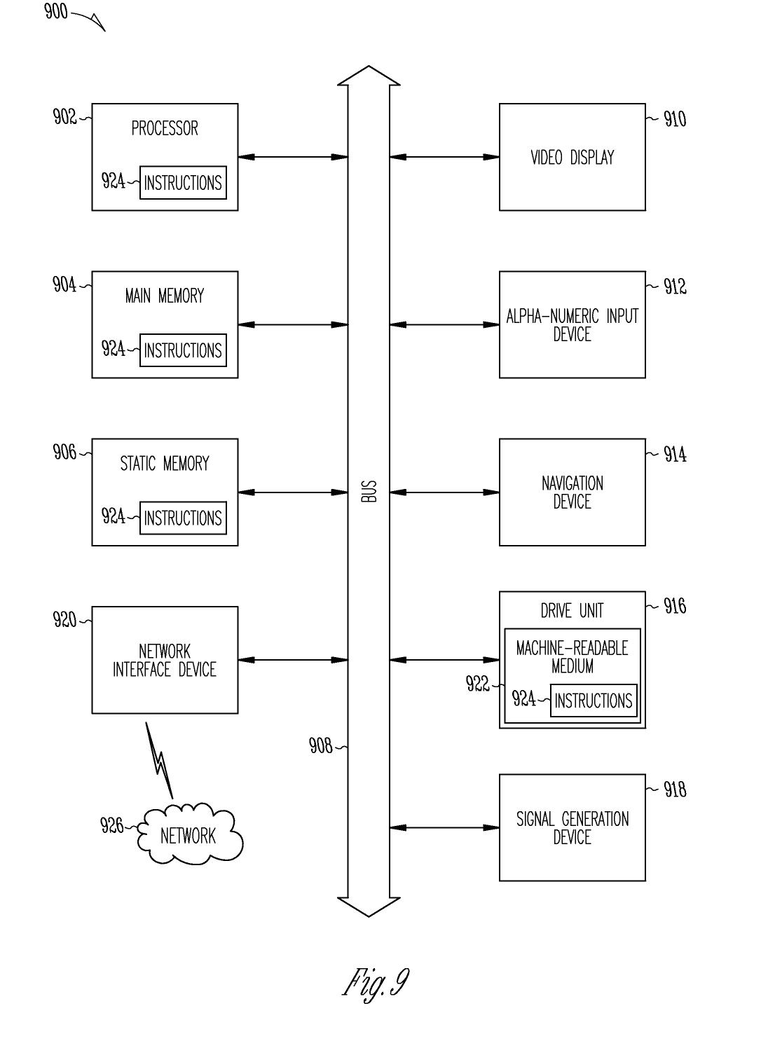

At operation 512, the processing module 212 may store the map information 206 in persistent storage 506. At operation 514, the processing module 212 may generate the randomized image information 154 and update the instruction information as further described in FIG. 8.

### Application of Base Address

At operation 516, the loading module 218 may identify and apply a new base address to the randomized image information 154 to generate the randomized executable image information 209. For example, the loading module 218 may identify a location of a block of the memory 220 of sufficient size to accommodate the randomized image information 154. Responsive to the identification, the loading module 218 may update the old base address “0” with a new base address for each of the instruction information 228 in the randomized image information 154 that utilizes absolute address information 254. For example, the loading module 218 may identify and apply a base address of “1000” to a first base offset of “100” in absolute address information 254 in instruction information 228 to generate an absolute address of “1100.” Further, the loading module 218 may write the absolute address of “1100” back into the absolute address information 254, thereby overwriting the base offset.

### Linking as Part of Loading

The loading module 218 may further identify other images (e.g., randomized image information 154 and/or other image information 152) (e.g., dynamically linked library) and link the other images to the present randomized image information 154. The loading module 218 may link the other images based on export information and import information, and the export information and import information of the other images.

At operation 518, the loading module 218 may load the randomized executable image information 209 into the memory 220 of the computer 202, and at operation 520, the computer 202 may execute the randomized image information 154.

FIG. 8 is a block diagram illustrating a method 600, according to an embodiment, to generate randomized image information 154 (e.g., instruction set values) and map information 206. The method 600 may commence at operation 602 with the processing module 212 randomizing the image information 152 to generate randomized image information 154 and the processing module 212 generating map information 206. At operation 604, the processing module 212 may update the instruction information 228 in the randomized image information.

In an embodiment, a method to randomize image information 152 and generate map information 206 uses the processing module 212 to randomize the function information 224 to generate randomized image information 154. For example, the processing module 212 may invoke the random number generator module 214, which may generate a random number that is used as a seed to generate the randomized image information 154 (e.g., a randomized instruction set). It will be appreciated by one having skill in the art that the random generation of a seed that is used to determine the instruction set values for each loading of a present image may be used to frustrate malware 116 that relies on static and unchanging instruction set values. It will further be appreciated that randomization is not limited to the loading of the present image but may be applied to the loading of each and every image.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 9 is a block diagram of a machine within which instructions may be executed for causing the machine to perform any one or more of the methodologies discussed herein. In one example embodiment, the machine may include the computer 202 (as illustrated in FIG. 2A). In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a (PC, a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a CPU, a graphics processing unit (GPU), or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

### Machine-Readable Medium

The drive unit 916 includes a machine-readable medium 922 on which is stored one or more sets of instructions (e.g., instruction information 228) and data structures 924 (e.g., storage blocks 226) (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. Instructions may also reside within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “disclosure” merely for convenience and without intending to voluntarily limit the scope of this application to any single disclosure or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Thus, systems and methods for defeating malware with randomized opcodes were disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

1. A computer processor comprising:
a first complete instruction set; and
a translator to translate the first complete instruction set into a second complete instruction set, the computer processor configured to execute operations using only the second complete instruction set.

2. The computer processor of claim 1, wherein the first complete instruction set is native to the computer processor; and wherein the second complete instruction set is not native to the computer processor.

3. The computer processor of claim 1, wherein a translation from the first complete instruction set to the second complete instruction set occurs at boot up of the computer processor.

4. The computer processor of claim 1, wherein a translation from the first complete instruction set to the second complete instruction set occurs in connection with loading program code for a process that is executed by the computer processor.

5. The computer processor of claim 4, wherein the process executes using the second complete instruction set; and wherein other processes in the computer processor execute using the first complete instruction set.

6. The computer processor of claim 1, wherein the translator uses a translate table that maps each instruction in the first complete instruction set to a corresponding instruction of substantially equivalent function in the second complete instructions set; and wherein the byte code for each instruction in the first complete instruction set is different than the byte code for the corresponding instruction of substantially equivalent function in the second complete instruction set.

7. The computer processor of claim 1, wherein the translator generates a randomized second complete instruction set.

8. The computer processor of claim 7, wherein the computer processor uses a translation seed to generate the randomized second complete instruction set.

9. The computer processor of claim 8, wherein the translation seed is stored in a secure location in a kernel of an operating system.

10. The computer processor of claim 1, wherein the computer is operable to transfer a process and a translate table associated with the process or a translation seed associated with the process to a second computer processor.

11. The computer processor of claim 1, wherein the translator generates a globally unique second complete instruction set in relation to one or more of a particular computer processor, a particular instantiation of an operating system, a particular process executing in the computer processor, and a particular thread associated with the particular process.

12. A process comprising:
maintaining a first complete instruction set in a computer processor;
translating the first complete instruction set into a second complete instruction set; and
executing a process on the computer processor using only the second complete instruction set.

13. The process of claim 12, wherein the first complete instruction set is native to the computer processor; and wherein the second complete instruction set is not native to the computer processor.

14. The process of claim 12, comprising translating the first complete instruction set into the second complete instruction at boot up of the computer processor.

15. The process of claim 12, comprising translating the first complete instruction set into the second complete instruction set in connection with loading program code for a process that is executed by the computer processor;
wherein the process executes using the second complete instruction set; and
wherein other processes in the computer processor execute using the first complete instruction set.

16. The process of claim 12, comprising mapping each instruction in the first complete instruction set to a corresponding instruction of substantially equivalent function in the second complete instructions set;
wherein the byte code for each instruction in the first complete instruction set is different than the byte code for the corresponding instruction of substantially equivalent function in the second complete instruction set.

17. The process of claim 12, comprising:
generating a randomized second complete instruction set; and
using a translation seed to generate the randomized second complete instruction set; and
storing the translation seed in a secure location in a kernel of an operating system.

18. The process of claim 12, comprising transferring a process and a translate table associated with the process or a translation seed associated with the process to a second computer processor.

19. The process of claim 12, comprising generating a globally unique second complete instruction set in relation to one or more of a particular computer processor, a particular instantiation of an operating system, a particular process executing in the computer processor, and a particular thread associated with the particular process.

20. A computer readable storage device comprising instructions that when executed by a processor execute a process comprising:
maintaining a first complete instruction set in a computer processor;
translating the first complete instruction set into a second complete instruction set; and
executing a process on the computer processor using only the second complete instruction set.
